(19) United States
(12) Patent Application Publication
(10) Pub. No.: US 2023/0249204 A1
(43) Pub. Date: Aug. 10, 2023

(54) LIQUID SPRAY SYSTEM AND METHOD OF SPRAYING

(71) Applicant: PPG Europe B.V., Uithoorn (NL)

(72) Inventor: Joseph Johannes Jules Verhoosel, Bergen Nh (NL)

(73) Assignee: PPG Europe B.V., Uithoorn (NL)

(21) Appl. No.: 18/002,422

(22) PCT Filed: Jun. 24, 2021
(86) PCT No.: PCT/EP2021/067424

§ 371 Date: Dec. 19, 2022

(30) Foreign Application Priority Data
Jun. 26, 2020 (EP) 20182654.2

(51) Int. Cl. B05B 7/24; B05D 1/02

(52) U.S. Cl. CPC B05B 7/241; B05B 7/2416; B05B 7/2475; B05B 7/2481; B05B 7/2494; B05D 1/02

(57) ABSTRACT

A liquid spray system (100) comprises a housing (110), a spray applicator (120) and an air pressurising device (130). The housing (110) comprises a retaining section (140) to receive a receptacle (200), the receptacle (200) comprising a flexible body (201, 202) having a reservoir (204) comprising a liquid for spraying, and a liquid outlet (205) in fluid communication with the reservoir (204). The retaining section (140) also comprises a receptacle compressor (170) configured to apply a compressive force to the flexible body (201, 202) to force liquid from the liquid outlet (205) of the receptacle (200). The spray applicator (120) is disposed remotely from the housing and in fluid communication with the liquid outlet of the receptacle (200). The air pressurising device (130) is in fluid communication with the spray applicator (120) to propel the liquid from the spray applicator (120).

### FIELD

The present disclosure relates in general to liquid spray systems and methods of using liquid spray systems, particularly, although not exclusively for spraying paint.

### BACKGROUND

One approach for the application of paint or other coating compositions is to spray the paint toward a surface. The spraying technique relies on the adhesion properties of the paint to the surface, but not all of the sprayed paint is capable of adhering to the surface and is consequently repelled.

Additionally, in some spray systems, high-pressure spraying is used to prevent wind interfering with the spraying of the paint during outdoor operation.

### SUMMARY

According to the present disclosure there is provided an apparatus and method as set forth in the appended claims. Other features of the disclosure will be apparent from the dependent claims, and the description which follows.

According to the present disclosure, there is provided a liquid spray system comprising:
a housing comprising:
   a retaining section configured to receive a flexible receptacle, the flexible receptacle comprising:
      a flexible body having a reservoir, the reservoir comprising a liquid for spraying; and
      a liquid outlet in fluid communication with the reservoir;
   the retaining section comprising a receptacle compressor configured to apply a compressive force to the flexible body to force liquid from the liquid outlet of the flexible receptacle;
a spray applicator disposed remotely from the housing and in fluid communication with the liquid outlet of the flexible receptacle; and
an air pressurising device in fluid communication with the spray applicator to propel the liquid from the spray applicator.

The receptacle compressor may be configured to abut the flexible body to apply the compressive force to the flexible body.

The receptacle compressor may comprise a bladder configured to expand to compress the flexible body. The bladder may be fluidly coupled to the air pressurising device. The bladder may be configured to expand upon receipt of air from the air pressurising device.

The receptacle compressor may comprise a pair of rollers, suitably arranged in parallel, and defining a nip therebetween for receipt of the flexible body. The nip may be sized to compress the flexible body. The receptacle compressor may comprise a drive section configured to rotate the rollers to draw the flexible body at least partially through the nip. The receptacle compressor may comprise a drive section configured to translate the rollers, thereby rolling the flexible body through the nip.

The receptacle compressor may comprise a first wall and a second wall defining a gap therebetween for receipt of the flexible body. The second wall may be configured to move towards the first wall to narrow the gap, thereby compressing the flexible body. The receptacle compressor may comprise a linkage connecting the first wall and the second wall. The receptacle compressor may comprise a drive section to rotate the linkage, wherein rotation of the linkage may cause translation of the second wall towards the first wall. The second wall may comprise a first portion retained in a substantially vertical plane during translation, and a second portion, hingedly connected to the first portion and the first wall.

The receptacle may comprise a first end having the liquid outlet; and a second end opposite the first end. The pouch compressor may be configured to progressively apply the compressive force starting at the second end and moving towards the first end.

The retaining section may comprise a recess having a shape complementary to a shape of the flexible body.

The receptacle compressor may comprise a pressure chamber configured to receive the flexible body. The pressure chamber may be fluidly coupled to the air pressurising device to increase the air pressure in the chamber, so as to compress the flexible body.

The flexible body may form an exterior of the flexible receptacle. The receptacle compressor may be configured to apply the compressive force to the exterior of the flexible receptacle. The receptacle may comprise or consist of a flexible pouch. The receptacle, suitably the pouch, may form a discrete subassembly or cartridge attachable to and detachable from the retaining section.

The retaining section may be configured to retain a plurality of flexible receptacles. The receptacle compressor may be configured to apply a compressive force to the flexible body of each receptacle. The system, suitably the housing, may comprise a mixer configured to mix the liquid forced from the liquid outlets of the flexible receptacles. The mixer may be disposed on a fluid flow path between the receptacles and the spray applicator. The mixer may comprise a static mixer.

The spray applicator may be a hand-held spray applicator.

The housing may be configured to rest on a floor or other support surface in use. The housing may be configured to be worn on a user’s back.

The liquid may be a coating composition. The coating composition may be used and/or formulated as a coating, varnish, lacquer, paint, stain and/or floor covering. The coating composition may be a wall paint, such as an interior wall paint or an exterior wall paint. The coating composition may be an interior wall masonry paint. The coating composition may be an exterior wall masonry paint.

There is also provided a kit of parts comprising the liquid spray system defined herein, and a receptacle. Further suitable features of the kit of parts are defined herein with respect to the liquid spray system, and may be combined in any combination.

There is also provided a spraying method comprising:
inserting a receptacle into a housing of a liquid spray system;
compressing the receptacle to force a liquid therefrom and convey the liquid to a spray applicator disposed remotely from the housing; and
propelling the liquid from the spray applicator using an air pressurising device.

The liquid may be a coating composition as defined herein. The coating composition may be applied to various substrates. Suitable substrates include, but are not limited to: wood; paper; dry wall; synthetic materials, such as plastics, including elastomeric substrates; glass; ceramic; metals, such as iron, steel or aluminium; concrete; plasterboard; gypsum-board; mortar; brick; and the like; and combinations thereof.

The substrate may comprise concrete, dry walls, brick or combinations thereof.

Thus, there is also provided a substrate coated on at least a portion thereof with a coating, the coating being applied using the spraying method according to the present invention.

The substrates may be pre-treated before application of the coating composition. The substrates may be post-treated after application of the coating composition. The substrates may be post-treated after application of the coating composition with any other compositions (which will be known to a person skilled in the art).

The spraying method may comprise:
inserting a plurality of receptacles into the housing of the liquid spray system, each receptacle comprising a component of a multi-component coating composition;
compressing the plurality of receptacles to force the liquid therefrom;
mixing the liquid to form the multi-component coating composition; and
propelling the multi-component coating composition from the spray applicator.

Further suitable features of the method are defined herein with respect to the liquid spray system, and may be combined in any combination.

There is also provided the use of a receptacle in the liquid spray system defined herein, the receptacle comprising: a flexible body having a reservoir, the reservoir comprising a liquid for spraying; and a liquid outlet in fluid communication with the reservoir.

Further suitable features of the receptacle are defined herein with respect to the liquid spray system, and may be combined in any combination.

### BRIEF DESCRIPTION OF DRAWINGS

For a better understanding of the disclosure, and to show how examples of the same may be carried into effect, reference will now be made, by way of example only, to the accompanying diagrammatic drawings in which:

FIG. 1 is a schematic perspective view of an example liquid spray system;

FIG. 2 is a schematic block diagram of the liquid spray system of FIG. 1;

FIG. 3 is a perspective view of an example receptacle;

FIG. 4 is a cross-section of the receptacle of FIG. 3;

FIG. 5A is a schematic cross-section of an example receptacle compressor;

FIG. 5B is a schematic cross-section of the receptacle compressor of FIG. 5B applying a compressive force to the receptacle;

FIG. 6A is a schematic cross-section of an example receptacle compressor;

FIG. 6B is a schematic cross-section of the receptacle compressor of FIG. 6B applying a compressive force to the receptacle;

FIG. 7A is a schematic cross-section of an example receptacle compressor;

FIG. 7B is a schematic cross-section of the receptacle compressor of FIG. 7B applying a compressive force to the receptacle;

FIG. 7C is a perspective view of the receptacle compressor of FIGS. 7A-B with the receptacle omitted;

FIG. 8 is a schematic cross-section of an example receptacle compressor; and

FIG. 9 is a schematic flowchart of an example spraying method.

In the drawings, corresponding reference characters indicate corresponding components. Elements in the figures are illustrated for simplicity and clarity and have not necessarily been drawn to scale. For example, the dimensions of some of the elements in the figures may be exaggerated relative to other elements to help to improve understanding of various examples. Also, common but well-understood elements that are useful or necessary in a commercially feasible example may not depicted in order to facilitate a less obstructed view of these various examples.

### DETAILED DESCRIPTION

In overview, examples of the disclosure provide a spray system operable with a flexible receptacle, such as a pouch. The spray system compresses the receptacle to force liquid therefrom, which conveys it to a spray applicator. An air pressurising device then propels the liquid from the applicator. In some examples, the receptacle is mechanically compressed by elements that abut the body of the receptacle. In other examples, the receptacle is placed in a chamber, and the system increases the pressure in the chamber to compress the receptacle, for example using the same air pressure device that propels the liquid from the applicator.

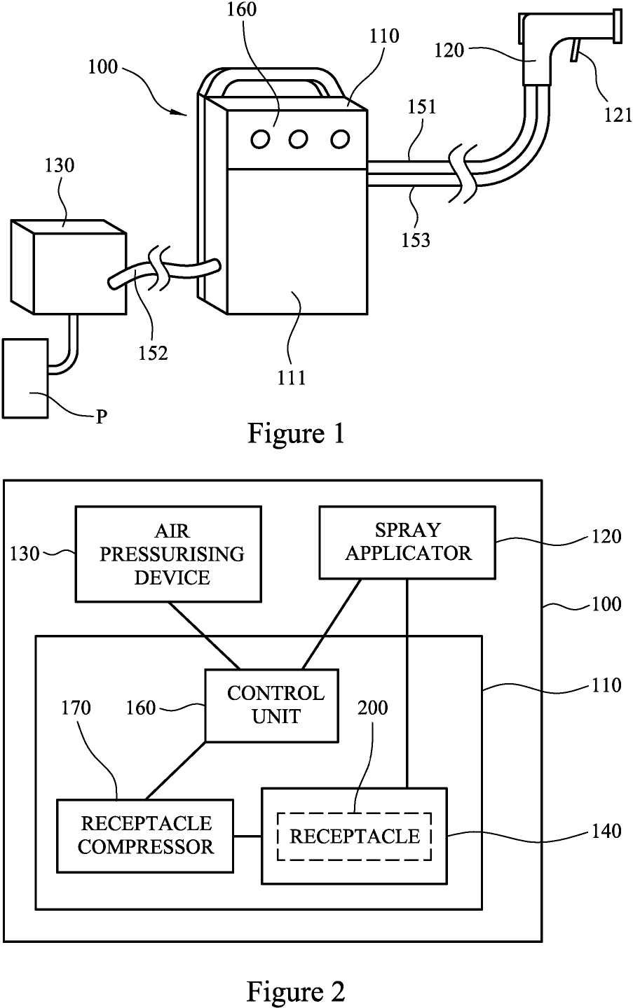

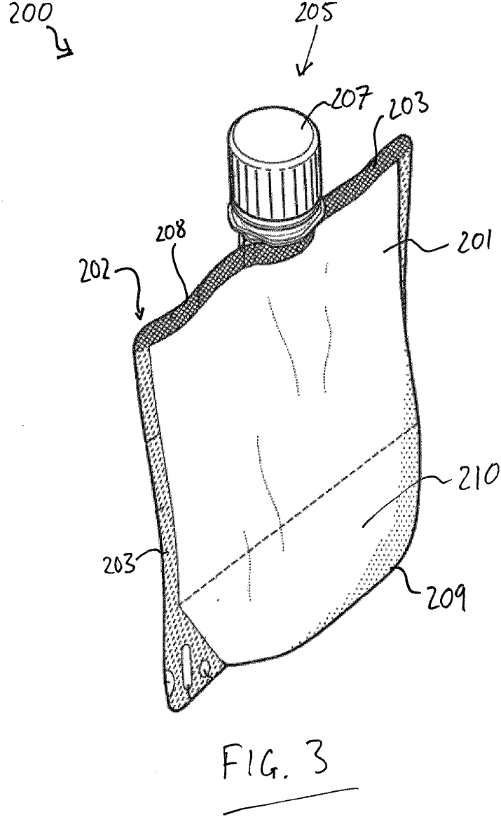

FIGS. 1 and 2 show an example spray system 100.

The spray system 100 comprises a housing 110, a spray applicator 120 and an air pressurising device 130.

The housing 110 comprises an enclosure, which may have a generally cuboid structure. In one example, the housing 110 is adapted to be rested on the floor or another support surface in use. For example, the housing 110 may comprise a base portion arranged to contact the floor or support surface. The housing 110 may additionally or instead be capable of being worn by a user. For example, the housing 110 may comprise suitable straps that allow it to be worn as a backpack.

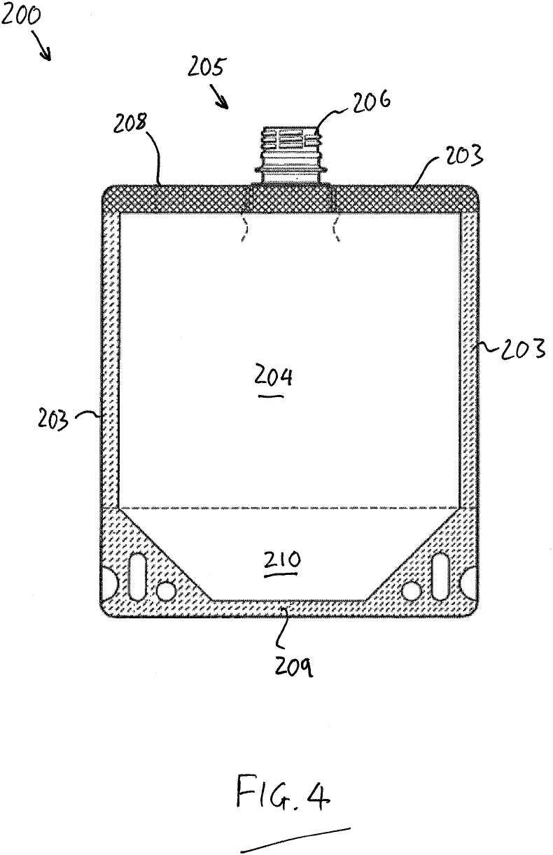

The housing 110 comprises a retaining section 140 configured to retain a receptacle 200. The receptacle 200 will be described in further detail with reference to FIG. 3 below. For example, the retaining section 140 may define a recess that is at least partially complementary in shape to the receptacle. In one example, the housing 110 comprises a door 111 or hatch, which may be opened to permit access to the interior of the housing 110, and particularly the retaining section 140. This may facilitate the insertion and removal of the receptacle 200.

In addition, the housing 110 comprises a receptacle compressor 170, configured to apply a compressive force to the receptacle to force liquid therefrom. The configuration of the receptacle compressor 170 will be discussed in further detail below.

The spray applicator 120 may take the form of a spray gun, configured to be held in a hand of the user. The spray applicator comprises a trigger 121 for activating the release of the liquid from a liquid outlet valve (not shown) of the spray applicator. The trigger 121 may be biased towards a non-activating position.

The spray applicator 120 is configured to receive liquid for spraying from the housing 110, and particularly a receptacle 200 disposed therein. For example, the spray applicator 120 may be in fluid communication with the housing 110 and receptacle 200 by virtue of liquid transmission line 151.

The spray applicator 120 is also configured to receive pressurised air from the air pressurising device 130. For example, the spray applicator 120 is in fluid communication with the air pressurising device 130 by virtue of first air transmission line 152, which connects the air pressurising device 130 and housing 110, and second air transmission line 153, which connects the housing 110 and spray applicator 120.

The spray applicator 120 may be disposed remotely from the housing 110. In other words, the spray applicator 120 and housing 110 may be configured for relative movement. Accordingly, the housing 110 may be disposed on the floor or worn on the user’s back whilst the applicator 120 is held in the user’s hand. The liquid transmission line 151 connecting the housing 110 and the spray applicator 120 may have a length of 0.5 m or more. For example, the length may be 0.7 m or more, or 0.8 m or more, or 0.9 m or more, or 1 m or more, or 1.1 m or more, or 1.2 m or more, or 1.3 m or more, or 1.5 m or more.

The air pressurising device 130 is configured to supply air to the spray applicator 120, so as to propel liquid from the spray applicator 120. The air pressurising device 130 is shown to be powered by mains electricity P. However, in other examples, the air pressurising device 130 may be battery powered. In still further examples, the air pressurising device 130 may be a canister of pressurised air. In some examples the spray system 100 may be supplied without an air pressurising device 130, so that a user can connect a separately obtained air pressurising device to the spray system 100.

In one example, the air pressurising device 130 is configured to supply air at a pressure of 3 bar or less to the spray applicator 120 and/or the receptacle 100. The use of a relatively low pressure may reduce overspray and splashback. This may be possible because the liquid is forced out of the receptacle 100 in the manner discussed below.

Whilst the example of FIG. 1 shows the air pressurising device 130 as a separate body, in some examples the air pressurising device 130 may be comprised in the housing 110 or detachably secured thereto.

The system 100 may comprise a control unit 160. The control unit 160 is configured to control the flow of liquid and/or air to the spray applicator 120. Accordingly, the control unit 160 may comprise suitable valves or other flow control elements, and may comprise suitable user input elements such as dials, switches and the like. Whilst the example of FIG. 1 shows the control unit 160 comprised in the housing 110, in other examples, the control unit 160 may be a separate body. In some examples, the control unit 160 may be detachably secured to the housing 110.

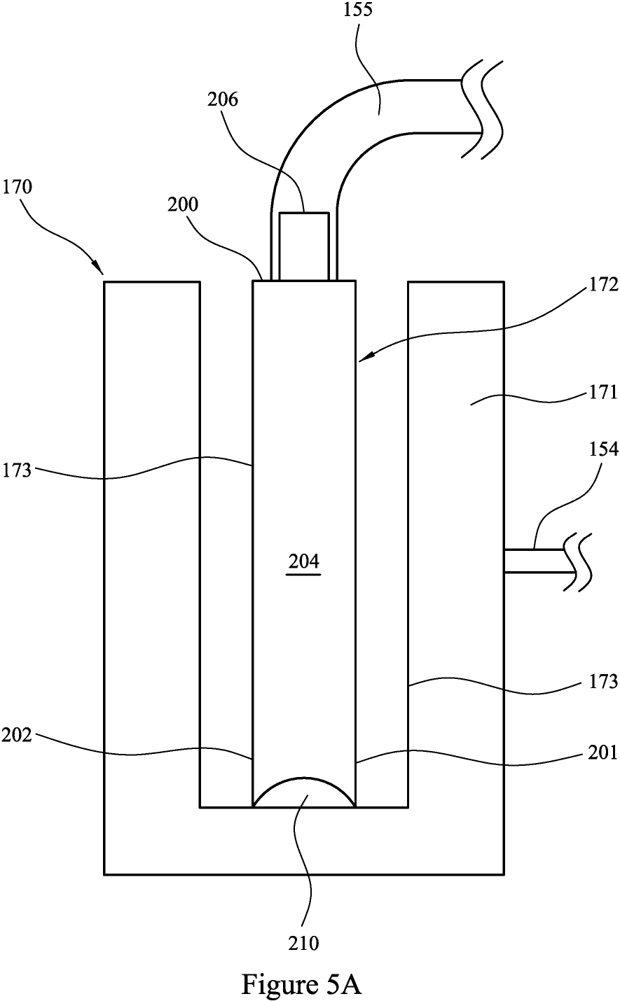

FIGS. 3 and 4 shows an example receptacle 200. The receptacle 200 is a flexible receptacle. By “flexible” it is meant a receptacle made of easily yielding materials such as film, foil or paper sheeting which, when filled and sealed, acquire pliable shape. Example flexible receptacles are bags, envelopes, pouches, sachets, wraps and the like.

In the example of FIGS. 3 and 4, the receptacle 200 takes the form of a flexible pouch. By the term “pouch” it is meant a receptacle shaped like or resembling a bag or pocket. It may for example relate to a sealed plastic or foil container made of a flexible sheet that can be bonded together along its seams to form a closed recipient.

The flexible pouch 200 comprises a flexible body. The body may be formed of flexible walls 201, 202, which are sealed together around their borders 203, so as to define a reservoir 204 for the storage of liquid. The body forms an exterior of the flexible pouch 200. The pouch 200 comprises a liquid outlet 205 in fluid communication with the reservoir. The liquid outlet 205 may comprise a spout 206. In one example, the spout 206 is sealed with a cap 207, which is removably connected to the spout 206, for example via a screw thread. The cap 207 may be provided with a tamper-evident seal. The liquid outlet 205 may be arranged at a first end 208 of the pouch 200. The pouch 200 may further comprise a second end 209, opposite the first end 208.

In one example, the pouch 200 is configured to stand in a generally upright position. Accordingly, the first end 208 may form a top end of the pouch 200 and the second end 209 may form a bottom end of the pouch 200. In one example, the bottom end 209 comprises a gusset 210 formed between the two walls 201, 202, which may be expanded to allow the pouch 200 to stand on the bottom end 209.

In one example, the approximate dimensions of the pouch are as follows: external height 205 mm, external width 175 mm, gusset height 52 mm.

In further examples, the receptacle 200 may be as described in the International Patent Application published under the number WO 2011/045329 A1, the contents of which are hereby incorporated by reference in their entirety.

The receptacle compressor 170 is configured to apply a compressive force to the exterior of the receptacle, which is formed by the flexible body. Accordingly, the body of the flexible pouch 200 is exposed to the receptacle compressor. The receptacle may consist of the flexible pouch 200. In other words, the flexible pouch 200 forms a discrete subassembly or cartridge, that can be removed and attached to the retaining section 140.

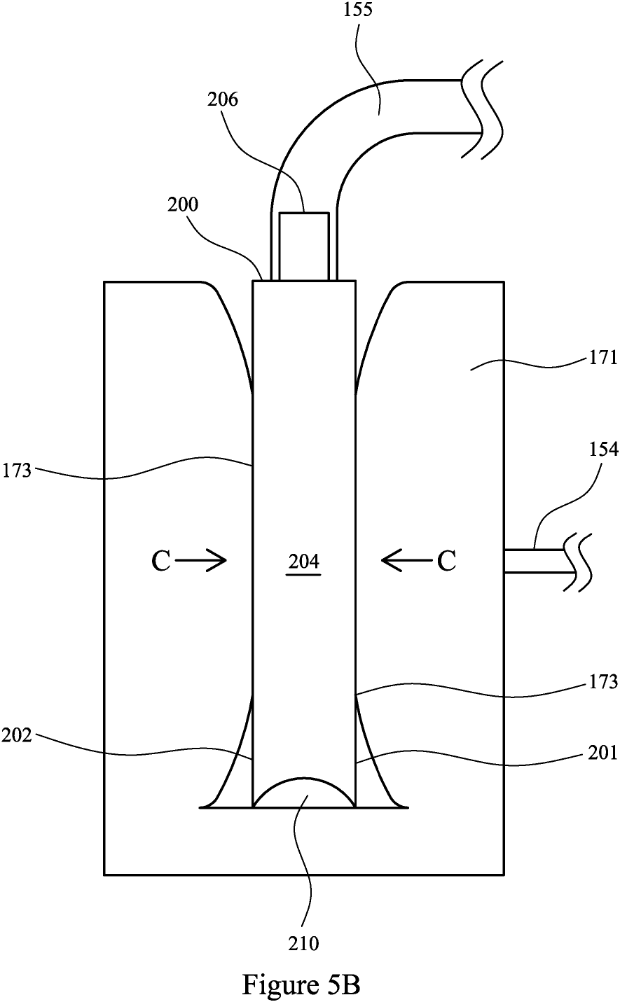

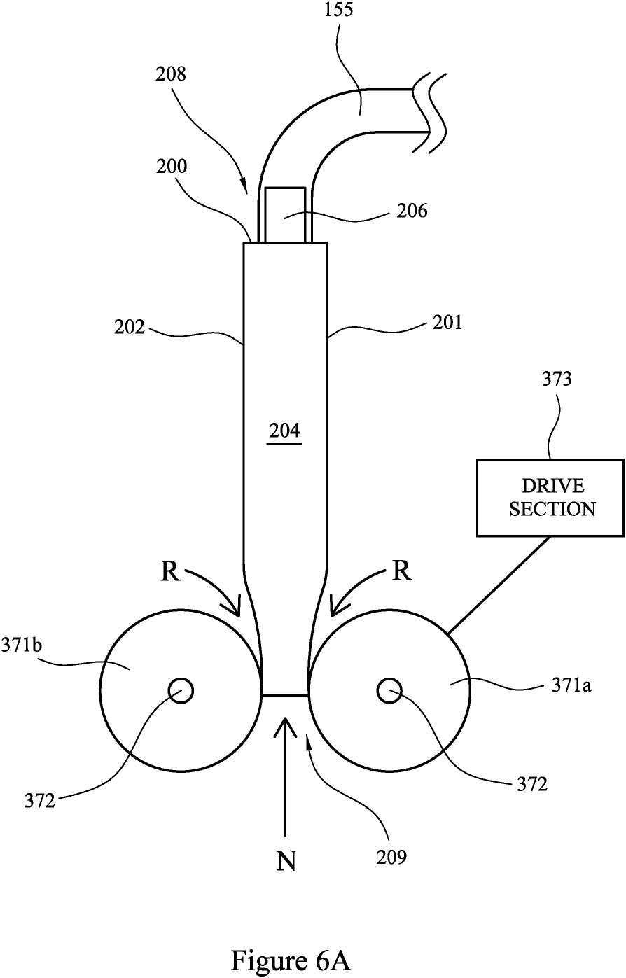

Turning now to FIGS. 5A-B, an example receptacle compressor 170 is shown. The receptacle compressor comprises an inflatable member 171, such as a bladder. The bladder 171 defines a recess 172 sized to accommodate the receptacle 200. Inner walls 173 of the recess are arranged proximate to the walls 201, 202 of the receptacle 200. The receptacle 200 is placed in fluid communication with the spray applicator 120, for example via a connecting conduit 155 which is in turn fluidly connected to the liquid transmission line 151. The bladder 171 is connected to an air supply, for example the air pressurising device 130, by via air inlet 154. The bladder 171 is resiliently deformable.

In use, air is supplied to the bladder 171. As shown in FIG. 5B, the increased air pressure inside the bladder 171 causes expansion of the walls 173 thereof, such that they abut the walls 201, 202 of the receptacle 200 and apply a compressive force C thereto. In FIG. 5B, the walls 173 have expanded sufficiently to begin to compress the receptacle 200. This causes the egress of liquid from the receptacle 200, which may in turn cause the liquid to be conveyed to the spray applicator 120. The walls 173 continue to expand to further compress the receptacle 200 until the reservoir 204 is substantially evacuated.

Upon reduction of the air pressure, for example upon opening of a release valve (not shown), the bladder 171 returns to the initial uninflated configuration shown in FIG. 5A.

In the example of FIGS. 5A-B, the bladder 171 defines a recess 172 with inflatable walls 173, so as to concurrently provide a compressive force to both walls 201, 202 of the receptacle 200. However, in other examples, the recess 172 may have one substantially rigid wall and one inflatable wall. Accordingly, the bladder 171 may apply the compressive force to a single wall of the receptacle.

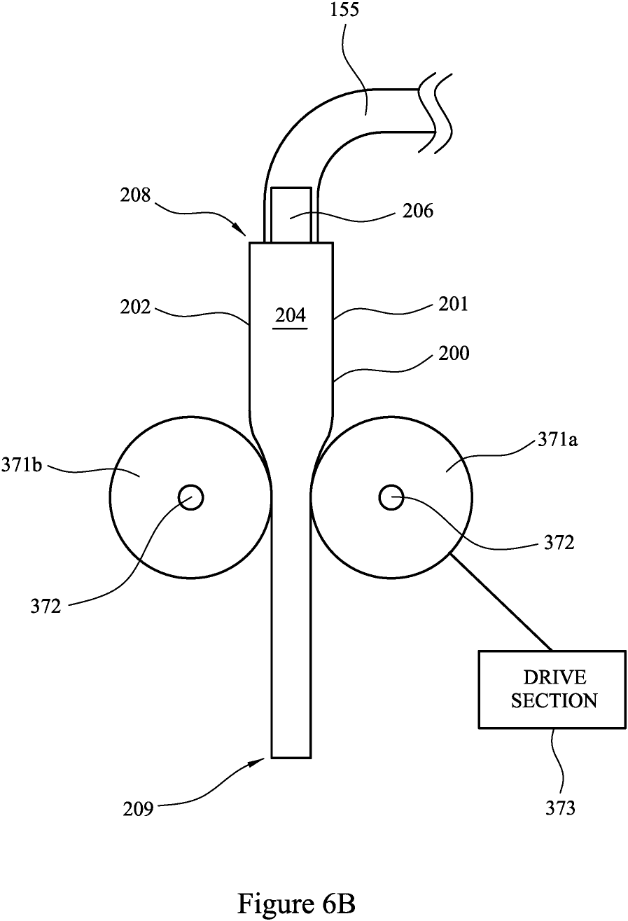

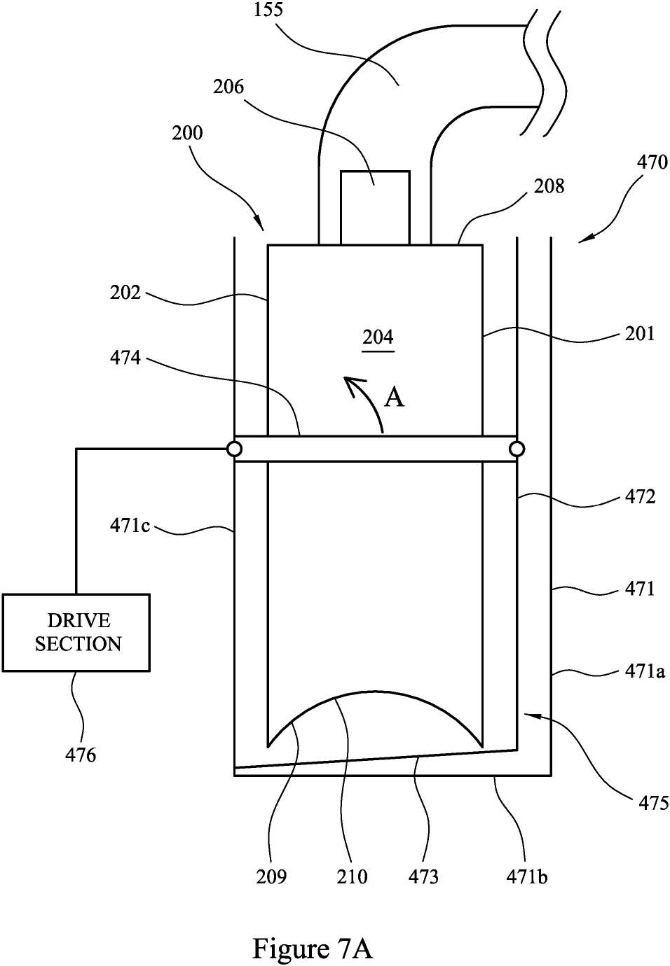

FIGS. 6A-6B illustrates another example receptacle compressor 370. The receptacle compressor 370 comprises a pair of rollers 371. The rollers 371 are spaced apart such that a nip N is defined between the rollers. For example, the rollers 371 are arranged so that their rotational axes 372 are substantially parallel.

The nip N is sized such that progression of the receptacle 200 through the nip N causes compression of the receptacle 200. For example, the width of the nip N may be substantially less than the depth of the filled receptacle 200. By “depth”, it is meant the distance between the walls 201, 202. The width of the nip N may for example correspond to the depth of the receptacle in a fully empty state.

In one example, one of the rollers 371 is a driven roller 371a. Accordingly, the receptacle compressor 370 may comprise a drive section 373 configured to rotate the roller 371a in the direction R to draw the receptacle 200 through the rollers 371. The drive section 373 may comprise a motor (not shown) and suitable gearing or linkages to connect the motor to the roller 371a. In some examples, both rollers 371 are driven. In one example, the rollers 371 comprise a high-friction surface to assist engagement with the receptacle 200.

In use, the bottom end 209 of the receptacle 200 is placed in the nip N. The roller 371a is driven, causing the receptacle 200 to be progressively drawn through the rollers from the bottom end 209 to the top end 208. As the receptacle 200 is drawn through the rollers 371, the relative narrowness of the nip with respect to the width of the receptacle 200 causes compression of the receptacle 200, thereby forcing egress of the liquid from the reservoir 204 via outlet 205 along conduit 155.

In another example, the rollers 371 are configured to translate over the receptacle 200. For example, the drive section 373 may be configured to translate the rollers 371 from the bottom end 209 of the receptacle 20 to the top end 208. In such an example, the rollers 371 may rotate freely rather than being driven.

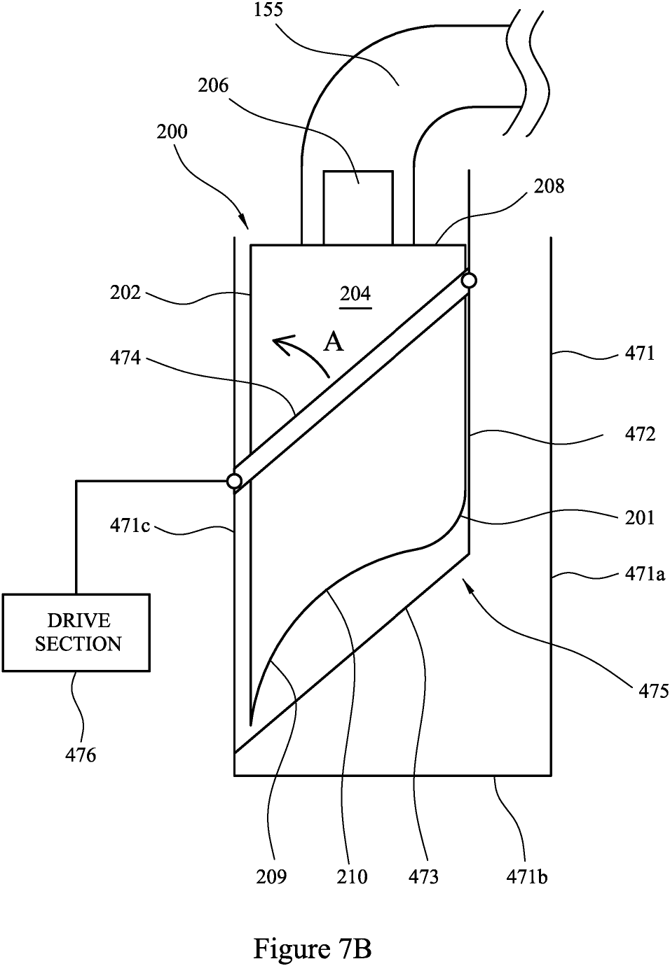

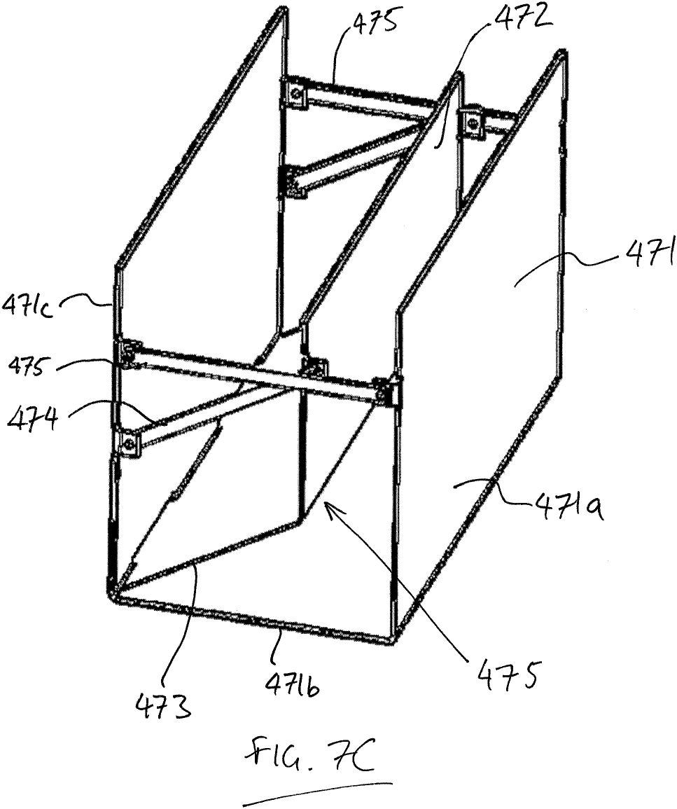

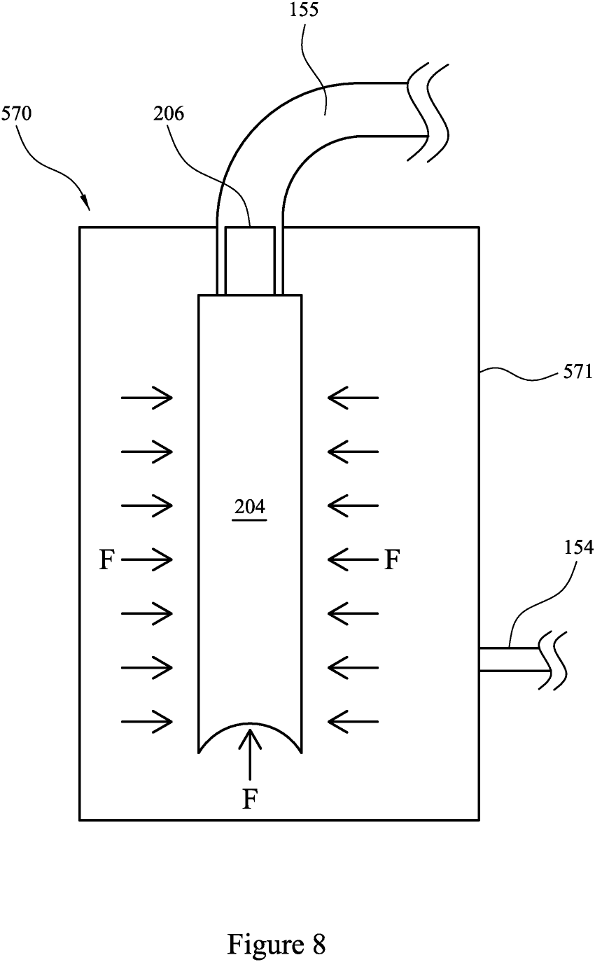

FIGS. 7A-C show another example receptacle compressor 470. The receptacle compressor comprises a frame 471. The frame 471 is generally U-shaped in cross-section, and comprise two parallel generally vertical panels 471a, 471c forming the side walls of the frame 471, connected by a generally horizontal panel 471b forming the bottom of the U.

The receptacle compressor 470 further comprises a movable wall 475 disposed within the frame 471. The movable wall 475 may be formed of a first panel 472 and a second panel 473. One side of the second panel 473 is hingedly connected to the frame 471, at a position proximate to the junction of the panels 471c and 471b. The opposing side of the second panel 473 is in turn hingedly connected to the first panel 472.

The receptacle compressor 470 may further comprise a linkage 474 configured to move the wall 475 towards the wall 471c. For example, the linkage 474 may comprise a pair of arms. Each arm extends between the wall 471c and wall 475, at respective ends of the frame 471. The arms are rotatably secured to their respective walls at either end. The linkage 474 is rotatable in the direction A shown in FIGS. 7A-B. The receptacle compressor 470 may comprise a drive section 476 to rotate the arms.

In use, a receptacle 200 is disposed in the gap between the wall 471c and the wall 475. The linkage 474 is rotated, causing the panel 472 to move in a generally arc-shaped path whilst remaining generally vertical. This in turn causes the panel 473 to rotate from a generally horizontal position towards a vertical position.

The panels 472 and 473 of the wall 475 apply a compressive force to the receptacle 200, squeezing the receptacle 200 so as to cause the egress of liquid from the reservoir. The configuration of the wall 475 is such that panel 473 may apply compression to the bottom end 209 of the receptacle 200 prior to compressing the top end 208.

In other examples, the wall 475 may be moved towards the wall 471c by virtue of a piston or other actuator. In further examples, the walls 475, 471c may move towards each other to narrow the gap therebetween.

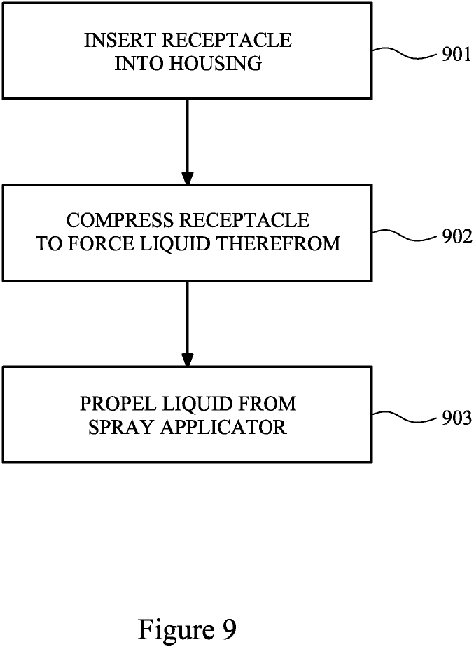

FIG. 8 shows another example receptacle compressor 570. The receptacle compressor 570 comprises a chamber 571, configured to receive a receptacle 200. The chamber 571 is disposed in the housing 110, and can removably receive the receptacle 200. The pressure chamber 571 is connected to an air supply, for example the air pressurising device 130, by via air inlet 154. The exterior of the receptacle 200 is exposed to the interior of the pressure chamber 571.

In use, the air pressure is increased in the pressure chamber 571. The increased air pressure acts on the exterior surface of the receptacle 200, as generally indicated by the arrows F. This causes compression of the receptacle 200, thereby forcing the liquid out of the reservoir 204.

Whilst FIG. 8 shows the application of increased pressure to both walls 201, 202, in other examples a single wall 201 may be compressed.

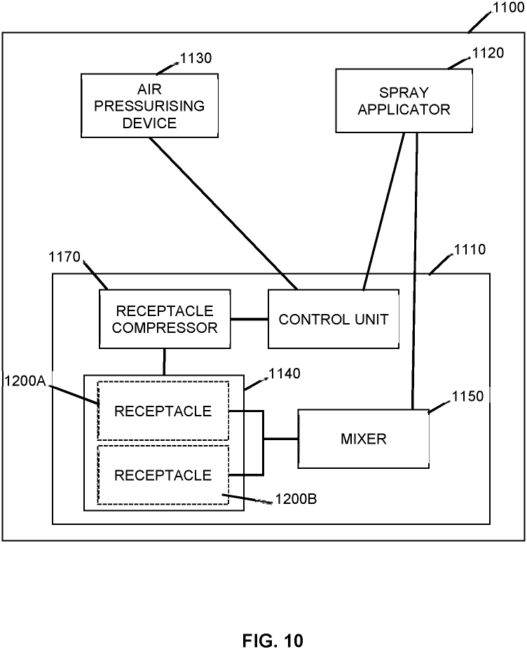

FIG. 9 illustrates an example spraying method. In block 901, a receptacle is inserted into the housing of a liquid spray system. In block 902, the receptacle is compressed to force a liquid therefrom, and convey the liquid to a spray applicator disposed remotely from the housing. In block 903, the liquid is propelled the spray applicator using an air pressurising device. The method may comprise further steps, as disclosed herein.

FIG. 10 shows a further example spraying system 1100. The spraying system 1100 is similar to the spraying system 100 described above, with corresponding components of the spraying system having the same reference numerals, incremented by 1000. In view of the similarities between the systems 100 and 1100, only the differences are discussed in detail below.

The example spraying system 1100 comprises a retaining section 1140 configured to retain two receptacles 1200A,B. The receptacle compressor 1170 is configured to compress the two receptacles 1200A,B.

In one example, the receptacle compressor 1170 comprises two of the receptacle compressors 170, 370, 470, 570 discussed hereinabove, each arranged to compress a respective one of the two receptacles 1200B. The receptacle compressors comprised in the receptacle compressor 1170 may each have the same structure, or may have different structures. In other words, in some examples the receptacle compressor 1170 comprises a first one of the receptacle compressors 170, 370, 470, 570, and another different one of the receptacle compressors 170, 370, 470, 570.

In a further example, one structure may be configured to compress two receptacles. For example, one inflatable member 171 may be comprise two recesses 172 or a recess 172 sized to receive two receptacles. In another example, one pressure chamber 571 may receive and compress two receptacles.

The spraying system 1100 also comprises a mixer 1150, configured to mix the liquid expressed from the two receptacles 1200A,B. The mixer 1150 comprises two inputs, each disposed in fluid communication with a respective one of the receptacles 1200, so that it can receive fluid from both receptacles 1200. The mixer 1150 also comprises an output in fluid communication with the spray applicator 1120, so as to provide a mixture of the liquid in the two receptacles 1200A.B to the spray applicator 1120. Accordingly, the mixer 1150 is disposed on a fluid flow path between the receptacles 1200A,B and the spray applicator 1120. The mixer 1150 may be disposed in the housing 1110.

In one example, the mixer 1150 comprises a static mixer. The static mixer 1150 may accordingly mix the liquid from the two receptacles without the use of moving components. For example, the static mixer 1150 includes a plurality of plates or baffles that induce turbulence or otherwise cause the liquids to mix with each other.

The mixer 1150 may additionally or alternatively comprise an active mixer, comprising moving components that mix the two liquids.

In use, the spraying system 1100 may operate with a two-component coating composition system, also referred to as 2k or 2-pack coating composition. Such coating composition systems may comprise two components that are stored separately and mixed shortly before being applied to a surface. For example, a two-component coating composition may comprise components that chemically react together to form a cured paint. crosslinked film, such as a first component that comprises a film forming component and a second component that comprises a crosslinking agent, operable to crosslink the film forming component to thereby form a cured film. Two component (2K) coating compositions are well known in the art.

Accordingly, in use receptacles 1200A,B each containing a different component of a two-component coating compositions are inserted into the retaining section 1140, whereupon they are compressed by receptacle compressor 1170 to express the liquid therefrom. The expressed liquid is conveyed to the mixer 1150, where it is combined to form the coating composition. The coating composition is then conveyed to the spray applicator, whereupon it is propelled from the spray applicator to coat a surface.

Although the example above includes a retaining section 1140 that receives two receptacles 1200A,B, further examples may include more than two receptacles and a mixer for mixing the liquid expressed from the more than two receptacles. Accordingly, multi-component coating compositions having any number of components may be accommodated.

The above-described examples advantageously involve a receptacle comprising liquid that is disposed remotely from the spray applicator (e.g. in a housing in a floor standing or backpack-worn configuration). This may allow for a relatively large reservoir of liquid to be used. This increases the time taken to exhaust the liquid in the reservoir, and thus extending the time between replacement of the receptacle. Accordingly, user convenience is improved. Furthermore, the use of fewer, larger receptacles reduces the ratio of liquid to packaging, reducing packaging costs and transport costs.

Still further, the disposal of the receptacle remote from the spray applicator ensures that the spray applicator can remain relatively lightweight and easy-to-handle, allowing for an increased degree of freedom of movement of the spray applicator. This advantageously assists the user in accurately dispensing the liquid, for example by accurately spraying a coating composition onto a surface.

As used herein, unless otherwise expressly specified, all numbers such as those expressing values, ranges, amounts or percentages may be read as if prefaced by the word “about”, even if the term does not expressly appear. Also, the recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all subranges subsumed therein.

Singular encompasses plural and vice versa. For example, although reference is made herein to “a” receptacle compressor, “a” linkage, “a” bladder, and the like, one or more of each of these and any other components can be used.

The terms “comprising”, “comprises” and “comprised of” as used herein are synonymous with “including”, “includes” or “containing”, “contains”, and are inclusive or open-ended and do not exclude additional, non-recited members, elements or method steps. Additionally, although the present invention has been described in terms of “comprising”, the liquid spray system detailed herein may also be described as “consisting essentially of” or “consisting of”.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

Advantageously, the configuration of the liquid spray system allows for the liquid to be propelled from the spray applicator at a relatively low pressure, because the liquid is forced from the receptacle by a receptacle compressor. This may reduce overspray and splashback, allowing the spray applicator to be placed in relatively close proximity to the surface being sprayed. Accordingly, as the distance between spray applicator and surface is minimised, the effects of environmental conditions, such as draughts and wind, are minimised. This may render the liquid spray system advantageously suitable for outdoor applications.

It will be appreciated that the liquid spray system, kit, method and use as described herein may be utilised with any type of coating composition. For example, the system, kit, method and use may be utilised to apply decorative coatings, such as masonry or wood paint for decorative purposes (such as the exterior or interior of buildings). The system, kit, method and use may be utilised for the outdoor or indoor application of coatings. The system, kit, method and use may be utilised for the application of protective coatings, such as protective marine coatings. For example, the system, kit method and use could be utilised for the painting of marine platforms, such as maintenance painting of sea oil platforms, for example.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing example(s). The invention extends to any novel one, or any novel combination, of the features disclosed in this specification (including any accompanying claims, abstract and drawings), or to any novel one, or any novel combination, of the steps of any method or process so disclosed.

Whereas particular embodiments of this invention have been described above for purposes of illustration, it will be evident to those skilled in the art that numerous variations of the details of the present invention may be made without departing from the invention as defined in the appended claims

1. A liquid spray system comprising:
a housing comprising:
a retaining section configured to receive a flexible receptacle, the flexible receptacle comprising:
a flexible body having a reservoir, the reservoir comprising a liquid for spraying; and
a liquid outlet in fluid communication with the reservoir;
the retaining section comprising a receptacle compressor configured to apply a compressive force to the flexible body to force liquid from the liquid outlet of the flexible receptacle;
a spray applicator disposed remotely from the housing and in fluid communication with the liquid outlet of the flexible receptacle; and
an air pressurising device in fluid communication with the spray applicator to propel the liquid from the spray applicator.

2. The system of claim 1, wherein the receptacle compressor is configured to abut the flexible body to apply the compressive force to the flexible body.

3. The system of claim 2, wherein the receptacle compressor comprises a bladder configured to expand to compress the flexible body.

4. The system of claim 3, wherein:
the bladder is fluidly coupled to the air pressurising device, and
the bladder is configured to expand upon receipt of air from the air pressurising device.

5. The system of claim 2, wherein the receptacle compressor comprises:
a pair of rollers arranged in parallel and defining a nip therebetween for receipt of the flexible body, the nip being sized to compress the flexible body.

6. The system of claim 5, wherein the receptacle compressor comprises a drive section configured to rotate the rollers to draw the flexible body at least partially through the nip or configured to translate the rollers, thereby rolling the flexible body through the nip.

7. The system of claim 2, wherein the receptacle compressor comprises:
a first wall and a second wall defining a gap therebetween for receipt of the flexible body, and
wherein the second wall is configured to move towards the first wall to narrow the gap, thereby compressing the flexible body.

8. The system of claim 2, wherein the receptacle comprises:
a first end having the liquid outlet; and
a second end opposite the first end,
wherein the receptacle compressor is configured to progressively apply the compressive force starting at the second end and moving towards the first end.

9. The system of claim 11, wherein the retaining section comprises a recess having a shape complementary to a shape of the flexible body.

10. The system of claim 1, wherein the receptacle compressor comprises a pressure chamber configured to receive the flexible body,
wherein the pressure chamber is fluidly coupled to the air pressurising device to increase the air pressure in the chamber, so as to compress the flexible body.

11. The system of claim 11, flexible body forms an exterior of the flexible receptacle, and the receptacle compressor is configured to apply the compressive force to the exterior of the flexible receptacle.

12. The system of claim 11, wherein the flexible receptacle consists of a flexible pouch.

13. The system of claim 11, wherein:
the retaining section is configured to retain a plurality of flexible receptacles,
the receptacle compressor is configured to apply the compressive force to the flexible body of each of the flexible receptacles, and
the liquid spray system comprises a mixer configured to mix the liquid forced from the liquid outlets of the plurality of flexible receptacles, the mixer disposed on a fluid flow path between the flexible receptacles and the spray applicator.

14. The system of claim 11, wherein the spray applicator is a hand-held spray applicator.

15. The system of claim 11, wherein the housing is configured to rest on a floor or other support surface in use.

16. The system of claim 11, wherein the housing is configured to be worn on a user’s back.

17. The system of claim 11, wherein the liquid is a coating composition, such as a paint or varnish.

18. A kit of parts comprising the liquid spray system of claim 11, and a receptacle.

19. A spraying method comprising:
inserting a receptacle into a housing of a liquid spray system;
compressing the receptacle to force a liquid therefrom and convey the liquid to a spray applicator disposed remotely from the housing; and
propelling the liquid from the spray applicator using an air pressurising device.

20. The method of claim 19, comprising:
inserting a plurality of receptacles into the housing of the liquid spray system, each receptacle comprising a component of a multi-component coating composition;
compressing the plurality receptacles to force the liquid therefrom;
mixing the liquid to form the multi-component coating composition; and
propelling the multi-component coating composition from the spray applicator.
